(19) United States
(12) Patent Application Publication
(10) Pub. No.: US 2008/0293425 A1
(43) Pub. Date: Nov. 27, 2008

(54) Portable wireless communication system

(75) Inventors: Ki Sheung Yuen, Brampton (CA); Ying Wai Chik, Mississauga (CA)

Correspondence Address: DENNISON ASSOCIATES, 133 RICHMOND STREET WEST, SUITE 301, TORONTO, ON, M5H 2L7, CA

(73) Assignee: Nautic Devices Inc, Mississauga (CA)

(21) Appl. No.: 12/149,419

(22) Filed: May 1, 2008

(30) Foreign Application Priority Data
May 18, 2007 (CA) 2589619

(51) Int. Cl. H04Q 7/20

(52) U.S. Cl. 455/450

(57) ABSTRACT

A wireless communication system operates without a base station and allows effective real time conferencing between two or more units. A particular communication protocol used by the devices synchronizes the signals. Received signals are combined to provide the full conferencing feature.

### FIELD OF THE INVENTION

The present invention relates to communication systems, and in particular, to wireless voice communication systems that operate without a base station or master device to control communication between the units.

### BACKGROUND OF THE INVENTION

There are a number of well known wireless voice two way communication systems that allow at least two users to be in communication with each other. The most common system includes cellular telephones where each unit is in communication with a base station or cellular system and the base station transmits the signal to the other unit. This type of system is effective within the area of reception.

It is also known in FRS (walkie-talkie) radios to allow communication between two devices where the communication between the devices is basically a public broadcast. In such walkie-talkie applications, the units do not function in a two way conference mode in that in the walkie-talkie system, the user actuates a button to transmit and only receives when the device is in the non transmit mode.

There are a number of applications where it is desirable to have effective communication between a number of users in close proximity to one another. For example, in a marine application, it may be desirable to have various members of the crew in effective communication with each other. Communication between the crew members is often difficult during bad weather, for example.

The present invention discloses a wireless LAN (local area network) system that does not use a base station or master unit for controlling communication between the different units.

One of the problems associated with a LAN system that uses a base station is the additional cost for the base station if a dedicated base station is used or in the case where one of the devices acts as a master for control and communication with others, the communication between the units, requires communication with the master. If there is a breakdown in communication between the units, i.e., the master goes out of range, communication between the other units is lost.

The present system overcomes a number of these deficiencies and operates using an efficient arrangement for controlling communications between the devices.

### SUMMARY OF THE INVENTION

The present invention is directed to a two way voice communication system where at least two portable wireless devices are in direct communication with each other without a base station and the system is expandable to allow communication between at least three portable devices. Each of the devices includes a communication protocol to determine a sequence of transmission time slots for transmitting signals between the devices. Each device uses one of the time slots such that only one device is transmitting during any one time slot. The communication protocol includes a time synchronizing feature based on transmissions of the devices to synchronize the time slots of the devices.

In a preferred aspect of the invention, the communication protocol, upon activation of any of the devices, the activated device initially performs a scan for received signals to determine if any of the other devices are transmitting. Any received transmitted signals of the other devices are used to provide timing information for synchronizing the time slot of the device with the previously activated devices. The communication protocol, upon activation of any of the devices, and confirmation by the scan that the other devices have not been activated, initiates a transmission signal of the activated device and thereby establishes a time reference signal that is used by subsequently activated devices to effect synchronization therebetween.

In a further aspect of the invention, the time slots of the devices are predetermined and the communication protocol of each device upon activation, performs the scan to provide a time reference point between the devices to synchronize the time slots for ongoing transmission between the devices.

In a preferred aspect of the invention, the devices are manufactured or are programmed to have an assigned particular time slot of up to eight time slots. Each device of the system includes its own time slot.

In a preferred aspect of the invention, the devices are divided into groups and each group includes a group identification that is part of any transmissions of the device. Each device only processes signals having this particular group designation. With this arrangement, the communication between devices of a group is not available to other devices that do not have this group designation.

In yet a further aspect of the invention, each group includes eight or less devices and the communication protocol includes at least eight time slots and each device is assigned one of the time slots whereby only one device transmits during any one time slot.

In a simplified aspect of the invention, each group is restricted to four devices and each device has a unique time slot of one of four time slots. Preferably, these time slots are assigned to the unit as part of the group at the time of manufacture.

The system can also include any number of additional devices that are only receivers or only acting as a receiver if all time slots have been assigned.

### BRIEF DESCRIPTION OF THE DRAWINGS

Preferred embodiments of the invention are shown in the drawings, wherein:

FIG. 1 is a front view of the communication device;

FIG. 2 is a back view of the communication device;

FIGS. 3, 4 and 5 are is a schematic layouts showing dedicated time slots and the approach for synchronization of the time slots of the devices of a group;

FIGS. 6 through 9 illustrate four devices and how these devices can group and regroup; and

FIG. 10 is an amplifying circuit used for processing the signal from the microphone;

FIG. 11 is a prior circuit for analogue to digital conversation of the signal;

FIG. 12 is a circuit used in the devices for analogue to digital conversion of the signal;

FIG. 13 illustrates processing of the converted digital signals; and

FIG. 14 is a block diagram of the processing function for conferencing between units.

### DETAILED DESCRIPTION OF THE PREFERRED EMBODIMENTS

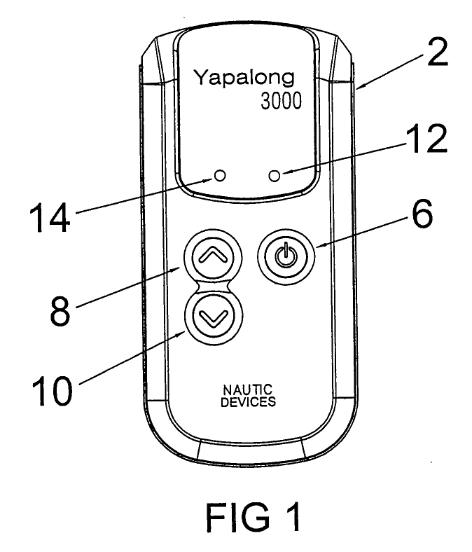

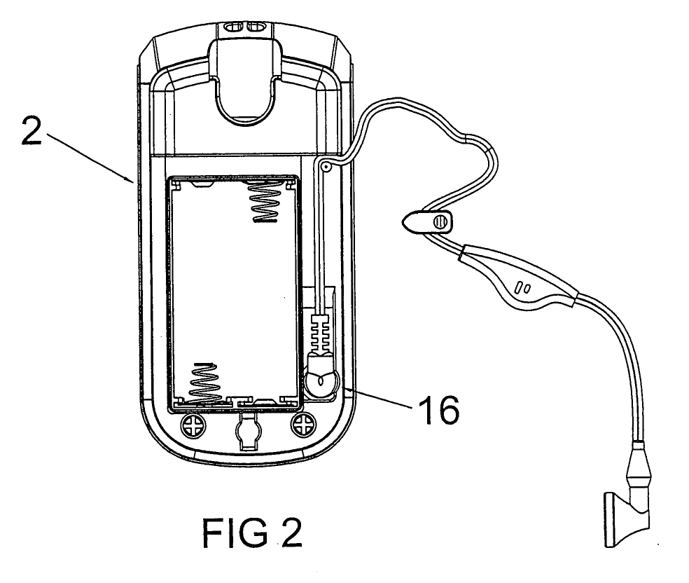

A personal wireless communication device 2 is shown in FIGS. 1 and 2 and includes a power switch 6, volume up control 8, and volume down control 10. The device also includes a first indicator 12 and a second indicator 14. Preferably, the first indicator is a red LED and the second indicator 14 is a green LED. A person using the portable wireless communication device 2 plugs a combination microphone and ear bud connections into a jack port located generally at 16.

The portable wireless communication device 2 cooperates with a series of these devices to provide two way continuous conference communication between the devices. This system of communicating devices allows each user of the device to have clear uninterrupted private communication with the other users of the group. For example, in a recreational sailing application, the skipper and the various members of the crew can be in continuous communication. This can be particularly advantageous for racing applications, anchoring applications or difficult operating conditions due to poor weather or night operation.

The portable wireless communication device 2, when activated, continuously monitors for signals from the related devices and provides those signals to the user through the ear buds. In addition, each device includes a microphone for transmitting voice signals to the other users. As can be appreciated, there are a number of different types of headset/microphones that can be used.

The “up” volume control 8 is used by the user to appropriately adjust the volume of the signal sent to his own ear buds, and the “down” volume control is used to decrease this value. A second adjustment is possible by using the power switch 6 in combination with either the “up” or “down” volume controls 8 or 10, to change the sensitivity of the microphone.

The controls 6, 8 and 10 of the device 2 operate in a particular manner as the controls have multiple applications. To turn the device on, the power switch 6 is held down for approximately three seconds until the green indicator identified as 14 flashes three times. The unit is now in communication with other activated units of the same group. To turn the device off, the power switch 6 is held down for approximately three seconds until the first indicator 12 (preferably a red indicator) flashes three times.

A further feature of the device 2 is the ability to turn the microphone off. This may be desirable where the particular crew member merely wants to listen to the conversation rather than transmit. The microphone is set in a “mute” mode by pressing and holding control 10 for approximately three seconds until the red indicator light 12 flashes once. The microphone may be released from the mute mode by pressing the “up” volume control 8 for approximately three seconds until the green indicator 14 flashes once.

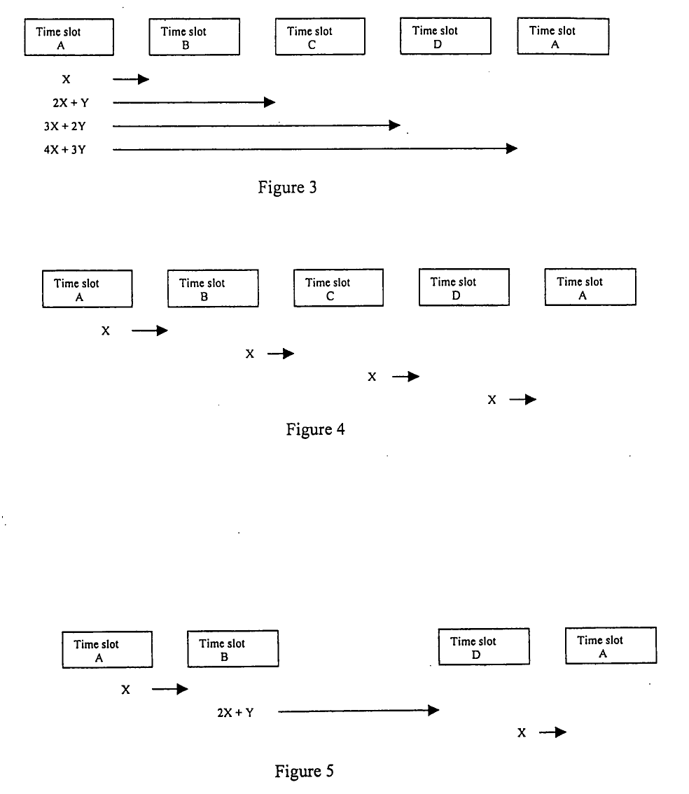

The individual portable wireless communication devices 2 are typically sold in a preassigned group such as a group of four devices. Each group includes a common group ID that is used to identify the signals of the devices of the group. Each of the devices uses a communication protocol that allows synchronization of the devices whereby any device in the group will only transmit in a particular time slot that has been previously assigned to the device. For example, if there are four devices of a group, the protocol includes at least four time slots shown as time slot A, time slot B, time slot C and time slot D in FIG. 3. The duration of each time slot is shown as “Y” microseconds and the gap between time slots is fixed at “X” microseconds.

When a device is first activated, it performs an initial scan for signals of any other member of the group. Each of the devices of the group transmits a signal that includes the group ID as well as the unit ID. Furthermore, each device of the group has been preprogrammed for transmitting during one of the time slots A, B, C, or D. If the device is the first activated device, the initial scan will fail to locate any received signals. As there are no other signals to synchronize with the device, it will start to transmit in its time slot on a regular basis. Therefore, the first activated device establishes the time relationship for the A through D time slots.

As other devices of the group are activated, they will also perform a scan for transmitted signals and will use the received signal of any of the units of the group to synchronize itself with the transmitted signals and appropriately transmit a signal in its time slot as has been predetermined. The signal of each device includes the assigned time slot information.

In this way, if the device that transmits in time slot A is first activated, then any other device that subsequently is activated, will appropriately position its time slot relative to the transmitted time slot of device A. For example, if a device of the group having time slot C is subsequently activated, it will position itself relative to the broadcast in time slot A to transmit in time slot C. Each device will continue to transmit in the particular time slot assigned to it and uses the signals from the other devices to appropriately align itself relative to the other transmissions. With this arrangement, any of the devices can be the first to be activated and the remaining devices essentially align themselves with the first activated device. There is no need for a base time synchronization between the devices as the transmitted signals are used to impart the time slot synchronization information. The protocol also includes the specified gap between time slot transmissions.

This particular arrangement is advantageous in that there is no master server type relationship between any of the units. If one of the units should drop out of range, there are no received transmissions from that unit in the particular time slot. If the unit comes back into range, it will still be aligned with the time slots of the members of the group. If two units effectively drop out of communication together, relative to two other units, two different conversations continue and these units will regroup automatically when they come back into range. This particular protocol is cost effective and provides a simple arrangement for grouping and regrouping of units.

In FIG. 3, the repeating sequence of time slots is shown and the timing information between the time slots is also identified by the arrows. The buffer space “X” microseconds, defines the time duration between adjacent time slots. The duration of a time slot is shown as “Y” microseconds. Thus, the time duration between the end of time slot A and the start of time slot C is (2X+Y) microseconds. The time duration between the end of time slot A and the start of time slot D is (3X+2Y) microseconds. The time duration between the end of time slot A and the start of time slot A is (4X+3Y) microseconds.

In FIG. 4, if device A is the only activated unit, it will transmit every (4X+3Y) microseconds. As shown in FIG. 4, if all four devices are activated, each device will transmit in its time slot and the time between each transmission will be “X” microseconds.

In FIG. 5, devices A, B, and D, are activated. Device A is transmitting during time slot A, device B is transmitting during time slot B, and device D is transmitting during time slot D.

The binding process (assigning of time slots and group ID) for the devices can be done in the factory or may be done by the end users. This binding process allows the different devices to be formed into a group. Each device includes a unique identity as well as a group identity. This information is typically stored in a non volatile memory of the device.

The binding process can be used by an end user to upgrade a smaller configuration, i.e., two or three devices, to a larger configuration at a later date.

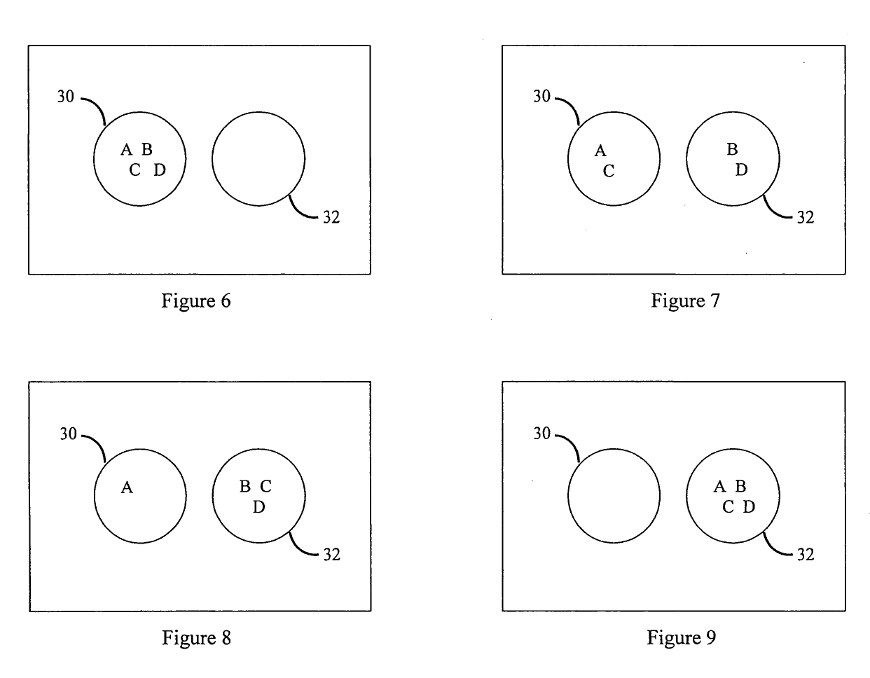

In FIG. 6, the group diagram shows two different regions 30 and 32 where all of the transmitting devices A, B, C and D, are located within the region 30. As can be appreciated, the various communication devices have a limited transmitting region and depending upon the particular circumstances and application of the devices, the devices may be out of range. In FIG. 6, it is shown that all devices are in range and all devices are transmitting.

In FIG. 7, devices A and C are located in region 30 and are thus in communication with each other whereas devices B and D have now moved to transmitting region 32. These devices are out of range with respect to devices A and C. Although the devices B and D have gone out of range with respect to A and C, they will continue to transmit in their particular time slots B and D. Devices B and D will be in communication with each other and units A and C will be in communication with each other.

In FIG. 8, device B has now joined units C and D in transmitting region 32, whereas device A is alone in transmitting region 30. Device A will continue to transmit in time slot A, and devices B, C, and D will continue to transmit in their particular time slots. Device A will not receive any of the signals from devices B, C, or D.

In FIG. 9, device A has now joined the remaining devices in transmitting region 32 and device A has left transmitting region 30. When device A joined the other devices in region 32, there was no need to re-establish synchronization as device A continued to transmit in its time slot A and thus effectively was automatically aligned with these devices once it was part of the same transmitting region. This arrangement that allows devices to go in and out of transmission with the other devices while maintaining synchronization, is helpful as any of the devices can temporarily lose communication for a variety of reasons during normal usage. Furthermore, there is no need for one of the devices to be activated and in communication to act as a server or coordinator device for the group.

The two way voice communication is in conference mode and allows any user to talk at any time and be heard by everyone else in the group. This system has particular application for group activities including ski schools, mariners, hunters, tourist groups, construction teams, cyclists and many small group coaching applications.

Each device includes a recording and compression function for transmitted signals in combination with a decompression function for received signals. This arrangement allows each device to transmit in one time slot and receive transmissions in all other time slots. Also, the group name associated with each transmission allows the full conferencing function between devices to be private. If desired, encryption of the signals can be used.

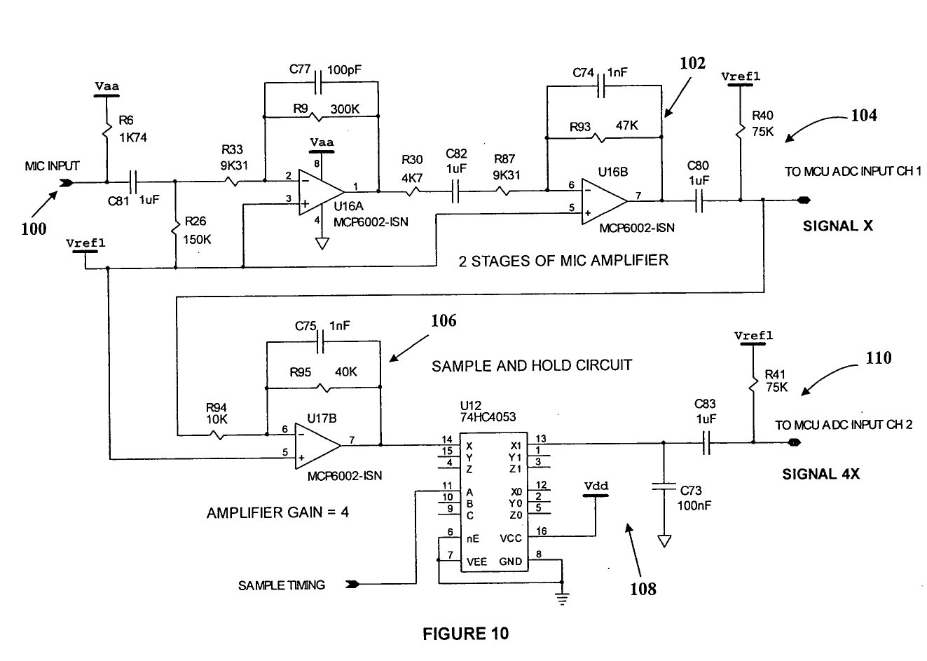

A particular implementation of the device and system is described with respect to FIGS. 10 through 14.

With current technology most microcontrollers offer 10-bit Analog to Digital Conversion (ADC) as standard features. Higher resolution ADCs are sometimes not available, or at a premium cost. A higher resolution ADC is desirable in two aspects, namely, a wider dynamic range and smaller quantization steps (or better granularity).

In a typical voice communication, a wide dynamic range is important. The human voice and ears has an extremely wide dynamic range by nature. In medium to low-end electronic products, the dynamic range is narrow compared to that of human hearing capability.

With standard voice coding techniques such as the PCM (ITU-T G.711 or CCITT G.726) and the variances and derivatives thereafter, the quantization step size is only important in low signal level. At medium to high signal levels, the encoding step size is actually much greater than the ADC quantization step size.

The present systems uses a technique to extend the dynamic range of 10-bit ADC to effectively 12-bit ADC. This is a factor of 4 times, or 400w better. The same technique can extend the voice signal dynamic range to 8 times or even higher if needed.

Most microcontroller with ADC features has a number of input channels (typically 8). The actual ADC circuitry can be switched dynamically to different input channels. Two ADC channels are used. The electrical circuit schematic is given in FIG. 10.

The microphone signal 100 shown in the circuit diagram of FIG. 10 is amplified by 2 stages of operational amplifier 102. This signal is fed into channel 1 of the ADC shown as 104. The signal is AC coupled by capacitor C80. The resistor R40 biases the DC voltage to Vref1, which is half value of the analog circuit supply Vaa. This signal is shown as signal X in FIG. 10. The same signal is amplified again by amplifier 106 with a gain of 4. This output signal is fed into a Sample-and-Hold circuit 108. The sample-and-hold circuit is implemented by an analog switch 74HC4053 and a holding capacitor C73. This signal held by C73 is then fed into the ADC channel 2 shown as 10 with a capacitor C83 and bias resistor R41. This is signal 4X as shown in FIG. 10.

The analog to digital conversions of the 2 channels should ideally be performed at the same time. In practice it is not possible, hence the sample-and-hold circuit. It will save the value of the 4X signal at the same time as the conversion of the X signal. After the ADC has completed the conversion with channel 1, it will perform the conversion of channel 2, which has the sampled and saved voltage of the 4X signal.

This hardware implementation and the scheme of the process of digital data from the 2 ADC channels has a number of advantages as outlined below.
Let Y represent the dynamic range of a higher bits ADC, say 12-bit. Then Y=4096.
The available ADC is 10 bit and has a dynamic range of Z=1024.
Consider a small input signal “S”, which produces a signal X that is equal or less than ¼ of the maximum value of the ADC. Should a 12-bit ADC be available, this output would range from 0 to 1023. With the scheme of the invention, the signal 4X with ADC channel 2 is used. The output is exactly 0 to 1023. Since the ¼ signal amplified by 4 times is exactly the maximum level of the ADC. It is concluded that the 10-bit ADC with a 4X signal produces the same range and granularity as a 12-bit ADC. Mathematically, Y=Z(4X) for values of S<¼Y.
Consider a large input signal “L”, which produces a signal X that is larger than ¼ of the maximum value of the ADC. Should a 12-bit ADC be available, this output would range from 1024 to 4095. With the invention scheme, the signal X with ADC channel 1 is used. The output of ADC channel 1 will range from 256 to 1023. This value is then multiplied by 4 in the calculation, which produces a result in 1024 to 4092. Thus a 10-bit ADC achieves the dynamic range of a 12-bit ADC. Mathematically, Y=4 Z(X) for values of S>¼ Y.
It should be noted that the granularity of the large signal “L” from the 10-bit ADC is 4 times larger than the 12-bit ADC. However, due to the encoding algorithm, it does not affect appreciably of the voice quality.

A program implementation in C code includes:

#define HighSaturationLimit 1023
#define LowSaturationLimit 0
void ConvertTo12BitADC (void)
{

if((ADC2 <= HighSaturationLimit) && (ADC2 >=
LowSaturationLimit))

{ voice = ADC2-512+2048; } // use 4X ADC value,
else
{ voice = (512-ADC1) *4+2048 ;}// else use 1X ADC

value
}

The discussion above uses 2 ADC channels, however, the same scheme can be extended to 3 or more ADC channels. The signal X can be amplified to produce 2× and 4× to improve the granularity; or X can be amplified to produce 4× and 8× to extend the dynamic range even more.

Since the ADC channels are available on the microcontroller, this implementation does not appreciably increase the complexity nor the cost.

In addition to the processing of the transmission signal of a device, improvements with respect to the reconstruction of the transmitted signals are also carried out.

In a microcontroller base system, digital-to-analog conversion (DAC) is usually done with Pulse Width Modulation (PWM), or some form of resistor networks (such as R-2R). Pulse Width Modulation has the benefit of simplicity in implementation and uses the least output pins on the microcontroller. An improved PWM implementation to achieve improvements in high quality voice reconstruction is also realized.

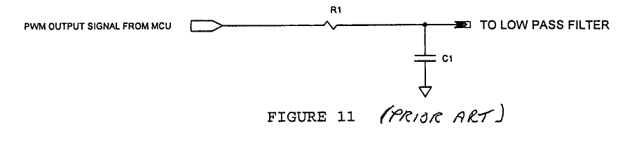

A simple PWM DAC is shown in FIG. 11.

In this simple configuration, only one PWM timer is used. Due to the timer limitation or the clock speed limitation, this implementation cannot meet a high quality 12-bit voice reconstruction.

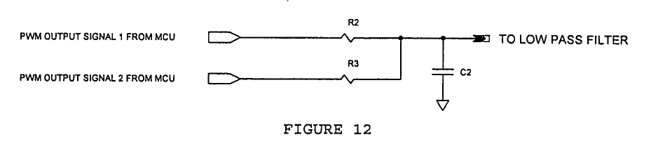

An improved design is shown in FIG. 12. In this design, 2 PWM timers and 2 output pins are used. The digital voice value, say 12 bits binary code, is split into two 6-bit values; each is used by a PWM counter to generate the PWM waveform. The value of the upper half is 64 times (2 to the power 6) that of the lower half. Thus R2 and R3 are in the ratio of 64 to 1.

The accuracy of this type of DAC depends on 2 things, namely, the timing accuracy of the PWM waveform, and the voltage stability of the PWM waveform. With a crystal clock generation, a microcontroller system is stable enough for voice recreation. However, the voltage supply, which in turn affects the voltage on the output pins, is typically noisy and not stable enough for high quality voice application.

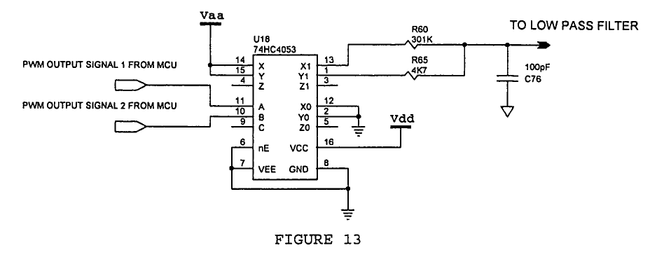

In FIG. 13, an analog switch 74HC4053 is used to switch the output signals on Pin 13 and Pin 1 to Vaa voltage supply or ground. The control signal for the switching is the PWM waveform from the microcontroller. These digital signals may not have a stable and clean voltage for either a digital high level or a digital low level. However, there is no problem in controlling the 74HC4053 for the switching.

In a system with both analog circuits and digital circuits, the power supply Vaa for the analog circuits needs to be kept clean and noise free. Whereas the digital supply Vdd is noisy. The input side of the switch (Pins 14 and 15) is connected to Vaa. If Vaa is not clean enough, other stable and clean power source can be used. With this implementation, the digital noise and the voltage ripple do not affect the DAC. Thus a high quality voice reconstruction is realized using a low cost analog switch.

For voice conferencing, each unit receives the compressed signal from other units, decodes these signals, sums the signals, and uses a speaker to reproduce the combined signals. The electronic summing of the signals can be done in either the analog domain or the digital domain.

In the analog domain, an operational amplify summing circuit is used. Given a number of input signals V1, V2, V3 . . . , the transfer function of the output signal Vout is:

Vout=k1V1+k2V2+k3V3=...

where k1, k2 and k3 are the gain factors and typically they are the same value k.

thous Vout=k(V1+V2+V3+...)

In the digital domain the addition of signals, which are already in digital values, can be summed algebraically. These digital values should be in the format of non-compressed, linear, signed integer values for accurate results. The transfer function is the same:

Vout=k(V1+V2+V3+ . . . )

There is also an alternative summing method, which selects, at any particular moment in time, the strongest signal of all the sources and use it as the only signal as output. (U.S. Pat. No. 4,757,493 Yuen/Moret. 1988)

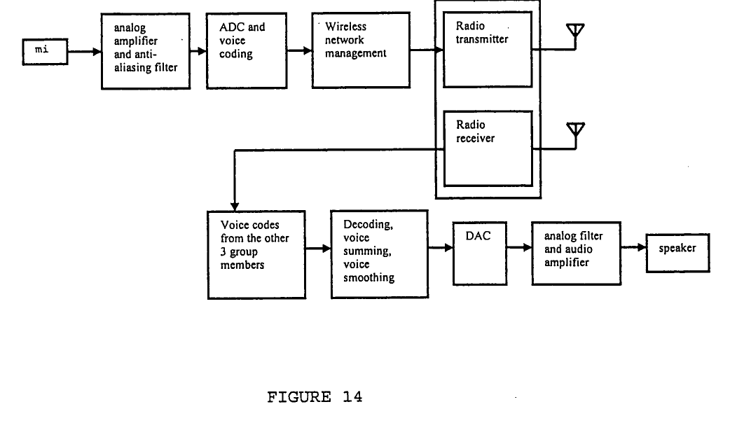

In the present peer-to-peer LAN system, the voice conferencing is performed by each handheld unit with a small 16-bit processor running at 8 Mhz. The voice summing is done in the digital domain, either method discussed above can be used successfully. A block diagram of the processing steps carried out by each unit to provide conferencing between multiple units is shown in FIG. 14.

### Voice Encoding

Voice transmitted over wire or wireless network are typically sampled at 8K sps (samples per second). The ITU G.711 recommendation specifies an ADC (analog to digital conversion) of 13 bits and 64 K bit/sec of coded PCM A-Law data. The present system uses 2 10-bit ADC available on the microcontroller to achieve the effect of a 12-bit ADC.

At the microphone, a filter with a cut off frequency of 3.5 K to 4 K is required to avoid aliasing of the ADC conversion. This is done with an active analog filter. The gain is also adjusted to optimize the dynamic range of the ADC.

### Voice Decoding

After the voice codes from the 3 group members are received in the allocated time slots, the data are decoded and summed. This is done at the same 8K sps rate. To further improve the filtering of the 8 KHz staircase waveform, a linear interpolation scheme is used, with 4 times oversampling (4×8=32 KHz).

The linear interpolation is achieved between 2 adjacent output points, i.e. 3 more points are created between 2 outputs points by interpolation.

The DAC is realized by PWM (pulse width modulation) method. At the DAC output, an analog filter with cutoff frequency of 3.5 K to 4 K is also required. With the help of the 32 K oversampling, the roll-off this filter is not critical.

Although various preferred embodiments of the present invention have been described herein in detail, it will be appreciated by those skilled in the art, that variations may be made thereto without departing from the spirit of the invention or the scope of the appended claims.

1. In a two way voice communication system comprising at least two portable wireless devices in direct communication without a base station and said system including the capability to expand to at least three portable devices, each of said devices including a communication protocol to determine a sequence of transmission time slots for transmitting signals between said devices and using one of said time slots for each device such that only one device is transmitting during any one time slot, said communication protocol including a time synchronizing feature based on transmissions of said devices to synchronize the time slots of said devices.

2. In a two way voice communication system as claimed in claim 1 wherein said communication protocol upon activation of any of said devices initially completes a scan of received signals to determine if any of said devices are transmitting and using any received transmitted signals of the other devices to provide the timing information for synchronizing the time slot of the device with the previously activated devices; said communication protocol upon activation of any of said devices and said scan determines that the other devices have not been activated, starts transmission of a signal and thereby establishes a time reference signal used by subsequently activated devices.

3. In a two way voice communication system as claimed in claim 2 wherein each time slot of said devices are predetermined and said communication protocol upon activation of a device performs said scan to provide a time reference point between said devices to synchronize said slots for ongoing transmissions between said devices.

4. In a two way voice communication system as claimed in claim 3 wherein said devices are part of a group that determines transmissions therebetween, and each device of the group includes in a transmission, a group identification code.

5. In a two way voice communication system as claimed in claim 4 wherein the group includes eight or less devices and said communication protocol includes at least eight time slots, and each device is assigned one of said time slots whereby only one device transmits during any one time slot.

6. In a two way voice communication system as claimed in claim 5 wherein said group includes four or less devices.

7. In a two way voice communication system as claimed in claim 6 wherein said communication protocol includes four time slots.

8. In a two way voice communication system as claimed in claim 1, including one more receive only devices.

9. In a two way voice communication system as claimed in claim 1 wherein said transmission time slots are of a short duration and each device records and compresses a signal for transmission and decompresses received signals to produce real time voice conferencing between devices.
